(19) United States
(12) Patent Application Publication
(10) Pub. No.: US 2026/0222539 A1
(43) Pub. Date: Jul. 30, 2026

(54) TECHNIQUES OF INTRA VIDEO CODING

(71) Applicant: MEDIATEK INC., Hsinchu City (TW)

(72) Inventors: Shih-Ta HSIANG, Hsinchu City (TW); Tzu-Der CHUANG, Hsinchu City (TW)

(21) Appl. No.: 19/148,457

(22) PCT Filed: Jan. 17, 2024
(86) PCT No.: PCT/CN2024/072764

§ 371 Date: Jul. 16, 2025

Related U.S. Application Data
(60) Provisional application No. 63/480,324, filed on Jan. 18, 2023.

(51) Int. Cl. H04N 19/105; H04N 19/159; H04N 19/172; H04N 19/593

(52) U.S. Cl. CPC H04N 19/105; H04N 19/159; H04N 19/172; H04N 19/593

(57) ABSTRACT

A coder calculates, for a current CU, TM costs for a plurality of candidate intra prediction modes. The coder selects one or more sets of intra prediction modes from the plurality of candidate intra prediction modes, each set including at least two intra prediction modes from the plurality of candidate intra prediction modes. The coder generates one or more fusion modes, each fusion mode blending a respective one set of intra prediction modes. The coder selects, from the plurality of candidate intra prediction modes, one or more intra prediction modes according to a predetermined criterion. The coder calculates fusion TM costs of the one or more fusion modes. The coder predicts the final prediction mode by comparing costs among the TM costs of the one or more intra prediction modes and the fusion TM costs of the one or more fusion modes.

### CROSS-REFERENCE TO RELATED APPLICATION(S)

This application claims the benefits of U.S. Provisional Application Ser. No. 63/480,324, entitled “Methods and apparatus for intra video coding” and filed on Jan. 18, 2023, which is expressly incorporated by reference herein in its entirety.

### BACKGROUND

### Field

The present disclosure relates generally to video coding systems, and more particularly, to techniques of intra video coding.

### Background

The statements in this section merely provide background information related to the present disclosure and may not constitute prior art.

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology-Coded representation of immersive media-Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus is a coder. The coder calculates, for a current coding unit (CU) of a video frame being coded, template matching (TM) costs for a plurality of candidate intra prediction modes. The coder selects one or more sets of intra prediction modes from the plurality of candidate intra prediction modes, each set including at least two intra prediction modes from the plurality of candidate intra prediction modes. The coder generates one or more fusion modes, each fusion mode blending a respective one set of intra prediction modes of the one or more sets of intra prediction modes. The coder selects, from the plurality of candidate intra prediction modes, one or more intra prediction modes according to a predetermined criterion. The coder determines to select a final prediction mode from among the one or more intra prediction modes and the one or more fusion modes. The coder calculates fusion TM costs of the one or more fusion modes. The coder predicts the final prediction mode by comparing costs among the TM costs of the one or more intra prediction modes and the fusion TM costs of the one or more fusion modes.

In another aspect of the disclosure, a method, a computer-readable medium, and an apparatus are provided. The apparatus may be a UE. The UE determines a resource allocation of a second physical downlink shared channel (PDSCH). The second PDSCH is on a second time-frequency resource transmitted from a wireless device. The second PDSCH carries data transmitted from a base station. The UE receives the second PDSCH from the wireless device. The second PDSCH is received on the second time-frequency resource according to the resource allocation. The UE decodes the data carried in the second PDSCH.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIGS. 1A and 1B illustrate an exemplary adaptive Inter/Intra video coding system incorporating loop processing.

FIG. 2 is a diagram illustrating coding units (CUs).

FIG. 3 is a diagram illustrating an example of a CTU recursively partitioned by quadtree with a nested multi-type tree.

FIG. 4 is a diagram illustrating a template-based intra mode derivation (TIMD) coding tool.

FIG. 5 is a flow chart of a method (process) for coding.

FIG. 6 is a block diagram of the VVC encoding system.

FIG. 7 is a block diagram of the CABAC engine.

FIG. 8 is a diagram illustrating a template and its reference samples used in TIMD.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

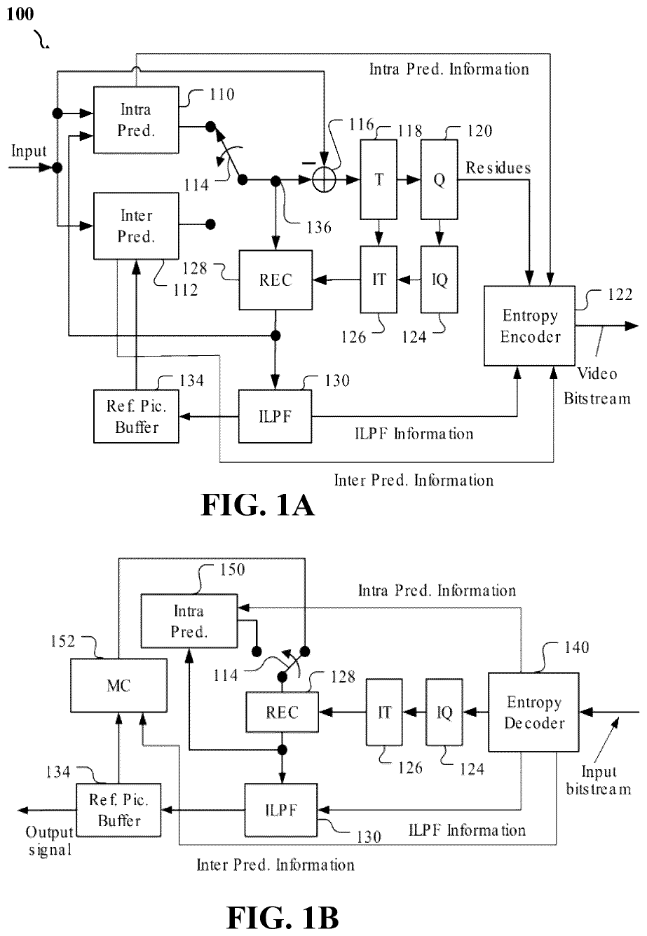

FIG. 1A illustrates an exemplary adaptive Inter/Intra video coding system incorporating loop processing. For Intra Prediction, the prediction data is derived based on previously coded video data in the current picture. For Inter Prediction 112, Motion Estimation (ME) is performed at the encoder side and Motion Compensation (MC) is performed based of the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H. 264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

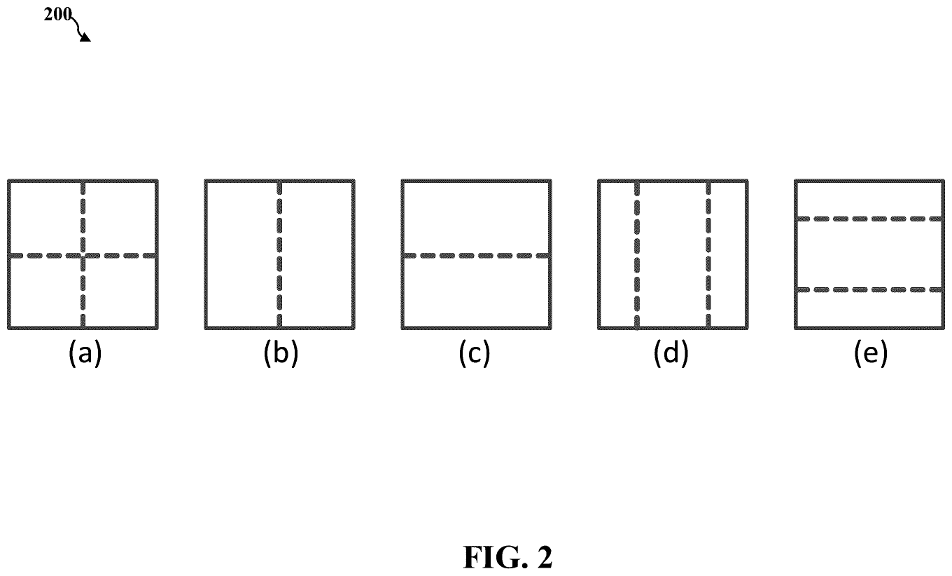

FIG. 2 is a diagram 200 illustrating coding units (CUs). In the Versatile Video Coding (VVC) standard, a coded picture is partitioned into non-overlapping square block regions represented by the coding tree units (CTUs). A coded picture can be represented by a collection of slices, with each slice comprising an integer number of CTUs. The individual CTUs within a slice are processed in a raster-scan order. A bidirectional predictive (B) slice may be decoded using either intra or inter prediction, employing at most two motion vectors and reference indices for predicting the sample values in each block. A predictive (P) slice is decoded using intra or inter prediction with no more than one motion vector and one reference index to predict the sample values of each block. An intra-coded (I) slice is decoded using only intra prediction.

A CTU may be divided into one or more non-overlapping coding units (CUs), utilizing a quadtree (QT) along with nested multi-type tree (MTT) structures which adapt to the various local motion and texture characteristics. A CU can be further sub-divided into smaller CUs using one of the five split types illustrated in FIG. 2.

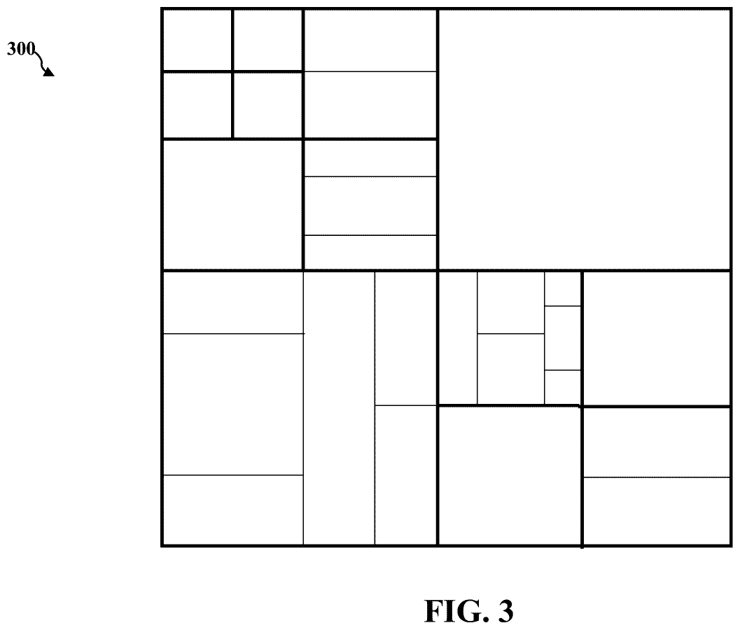

FIG. 3 is a diagram 300 illustrating an example of a CTU recursively partitioned by QT with the nested MTT. Each CU contains one or more prediction units (PUs). The prediction unit, along with its associated CU syntax, serves as a basic unit for signaling the predictor information. The designated prediction process is applied to predict the values of the associated pixel samples within the PU. Each CU may contain one or more transform units (TUs) representing the prediction residual blocks. A transform unit (TU) includes a transform block (TB) for luma samples and two corresponding transform blocks for chroma samples, where each TB corresponds to a residual block of samples from one color component. An integer-based transform is applied on a transform block. The level values of quantized coefficients, along with additional side information, are entropy-coded into the bitstream. The terms “coding tree block” (CTB), “coding block” (CB), “prediction block” (PB), and “transform block” (TB) define the 2-D sample array of a single color component associated with a CTU, CU, PU, and TU, respectively. As such, a CTU includes a luma CTB, two chroma CTBs, and the associated syntax elements. This relationship is consistent for CU, PU, and TU as well.

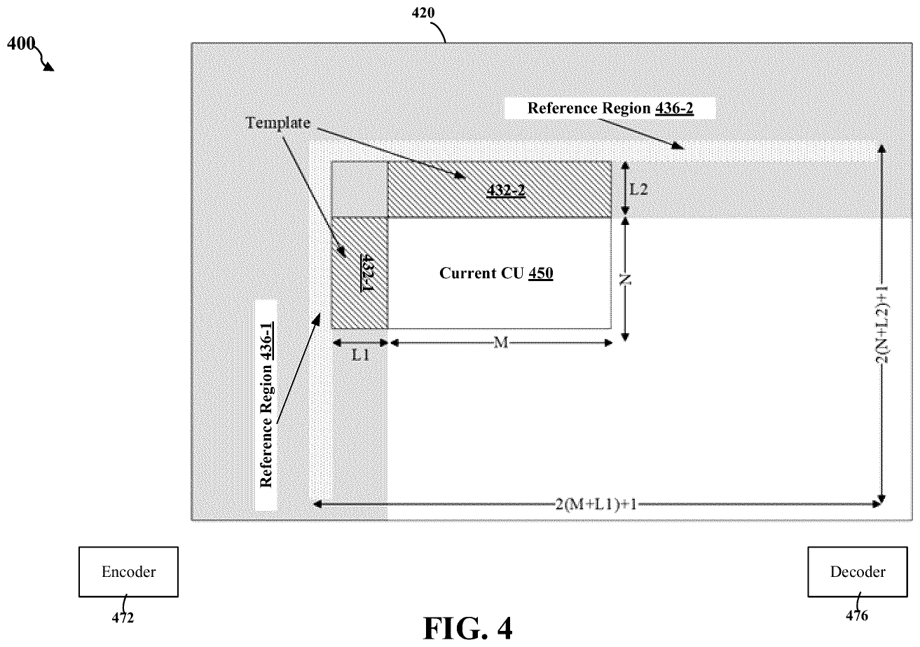

FIG. 4 is a diagram 400 illustrating a template-based intra mode derivation (TIMD) coding tool. An encoder 472 and a decoder 476 may use the TIMD coding tool to predict sample values of a current frame 420.

The current frame 420 contains a coding unit 450 that is currently being coded. The coding unit 450 is associated with a template 432-1 and a template 432-2, which are associated with a reference region 436-1 and a reference region 436-2.

In this example, the coding unit 450 has a length of M pixels and a width on N pixels. The coding unit 450 has a length of M pixels and a width of N pixels. The template 432-1 has a length of L1 pixels and a width of N pixels, and is on the left side of the coding unit 450. The template 432-2 has a length of M pixels and a width of L2 pixels, and is on top of the coding unit 450. The reference region 436-1 has a width of 2(N+L2)+1 pixels, and is to the left of the template 432-1. The reference region 436-2 has a length of 2(M+L1)+1 pixels, and is on top of the template 432-2. The reference region 436-1 and the reference region 436-2 form an L shape.

When utilizing the TIMD coding tool, the encoder 472/decoder 476 derives a most probable intra prediction modes (MPM list) for the current coding unit (CU) 450 of the current frame 420. In one example, the MPM list includes 22 intra prediction modes, which can be augmented with commonly used modes like DC, horizontal, and vertical. These modes are candidates considered for matching against the template region, which serves as a reference for intra prediction.

For each intra prediction mode in the MPM list, the encoder 472/decoder 476 performs a template matching process. The template matching process involves comparing the predicted sample values against the actual reconstructed sample values adjacent to the CU 450. The areas surrounding a coding unit, designated as template 432-1 and template 432-2, contain the reconstructed samples that serve as references for predicting the content of the CU 450. Here, template 432-1 is situated to the left side of the coding unit 450, and template 432-2 is located just above the coding unit 450.

During the TIMD cost calculation for each candidate intra prediction mode, the Sum of Absolute Transformed Differences (SATD) is employed as a cost metric. SATD is a measure that quantifies the accuracy of a prediction by calculating the absolute differences between the predicted and actual reconstructed samples, followed by a transformation to compensate for discrepancies due to signal transformation during the encoding process.

The SATD calculation is fundamentally a comparison between the predicted samples and the reconstructed samples within the templates 432-1 and 432-2.

For each candidate intra prediction mode being evaluated, the process begins by taking previously reconstructed sample values from the reference regions 436-1 and 436-2.

Using the sample values from these reference regions 436-1 and 436-2, the encoder 472/decoder 476 generates predictions for the template regions 432-1 and 432-2. These predictions aim to simulate the sample values that would be in the current CU 450 if that particular prediction mode were to be used.

The predicted sample values for the template regions 432-1 and 432-2 are then compared to the actual reconstructed sample values in the same template regions. This comparison involves calculating the absolute differences between each pair of corresponding predicted and reconstructed samples, then applying a transform to these differences, summing them up to yield the SATD for that prediction mode.

The SATD gives a quantifiable measure of the error or discrepancy introduced by using a particular prediction mode. Lower SATD values indicate a higher efficiency of the prediction mode, as they signify smaller differences between predicted and reconstructed samples.

SATD cost calculations assess the efficiency of candidate prediction modes by comparing prediction outcomes with actual reconstructed samples within the template regions adjacent to the current CU 450. By accurately predicting the values for these template regions, the encoder 472/decoder 476 can estimate how well a candidate mode will perform for the CU itself, thus enabling the selection of the most fitting intra prediction modes.

The process operates under the assumption that the neighboring regions' reconstructed values are good approximations of the current CU's original pixel values. Consequently, a low SATD score would indicate that the predicted samples closely resemble the reconstructed samples, suggesting that the candidate prediction mode is efficient for encoding the current CU 450 of the current frame 420.

By iterating this comparison across all intra prediction modes in the MPM list, the TIMD process can select the modes that most closely align with the samples of the reconstructed regions (template and reference regions). Ultimately, the modes yielding the two lowest SATD costs are selected as Mode1 and Mode2, with Mode1 having the lowest SATD and thus being the preferred mode for predicting the CU 450. Through this approach, video coders can achieve higher compression efficiency by minimizing the prediction errors and reducing the amount of information that needs to be transmitted in the video bitstream for accurately reconstructing the video at the decoder's end.

As described supra, two distinct intra prediction modes—Mode1 and Mode2—are identified from the MPM list. The encoder 472/decoder 476 initially applies a Position Dependent Intra Prediction Combination (PDPC) process to the identified intra prediction modes. The PDPC refines the prediction by considering the position of pixel samples, thereby enhancing the prediction's accuracy. After the PDPC process, the encoder 472/decoder 476 may fuse the two modes by assigning them appropriate weights. This refined and weighted intra prediction is then utilized to encode the current coding unit 450. Furthermore, in certain configurations, a specific syntax flag within the CU 450 may be encoded to denote the use of the TIMD tool for this encoding purpose.

In TIMD, the encoder and decoder use the Sum of Absolute Transformed Differences (SATD) to quantify the efficiency of different intra prediction modes for coding the CU (e.g., the coding unit 450). The aim is to predict the sample values of the CU using the closest matching intra prediction modes, which are derived from the reconstructed sample values of the reference regions adjacent to the CU, denoted as reference region 436-1 and reference region 436-2. SATD serves as a cost metric that captures the error between the predicted and actual sample values after a transformation process, and is used to derive the TM cost of Mode 1 (costMode1) and the TM cost of Mode 2 (costMode2).

More specifically, to calculate the costs costMode1 and costMode2 for the two most efficient intra prediction modes under consideration, Mode1 and Mode2, the SATD metric is used as follows:

$$SATD = {\sum }_{p} \vert T ( P r e d ( p ) - R e c ( p ) ) \vert ,$$

where Pred (p) is the predicted sample at position p within the templates 432-1 and 432-2 using a candidate intra prediction mode from the MPM list, Rec(p) is the reconstructed sample at the position p, T(⋅) is a transform function to compensate for quantization effects.

The SATD is calculated for each intra prediction mode in the most probable mode (MPM) list derived for CU 450. The intra prediction modes from this list are tested against the template regions by calculating the SATD for each mode, leading to the determination of costMode1 and costMode2 using the following equations:

$$costMode 1 = {min}_{mode ∈ MPM list} SATD ( mode ) ,$$

$$costMode 2 = {{min}_{mode ∈ MPM list}}_{mode \neq Mode 1} SATD ( mode ) .$$

Here, costMode1 is the SATD cost for Mode1, which is the mode with the lowest SATD among all candidates, signifying the best prediction so far. Subsequently, costMode2 is the SATD cost for the next best prediction, Mode2, which has the second-lowest SATD while being different from Mode1.

Upon calculating costMode1 and costMode2, their relative costs are compared using a threshold criterion to decide on the application of mode fusion. If costMode2 is less than twice costMode1, the cost informs the weighting strategy which ultimately determines the fusion of the prediction signals from Mode1 and Mode2 for the TIMD process:
If costMode2<2·costMode1, then fusion is applied.

Otherwise, fusion is not applied.

Using the calculated TIMD costs, the weights for Mode1 and Mode2 are constructed to create a weighted prediction:

$$weight 1 = \frac{costMode 2}{costMode 1 + costMode 2} ,$$

$$weight 2 = 1 - weight 1.$$

These weights are then applied to obtain a fused prediction signal Pred_{fused}(x,y) for any pixel at position (x,y) within the CU 450:

$$P r e {d}_{fused} ( x , y ) = weight 1 \cdot {Pred}_{1} ( x , y ) + weight 2 \cdot {Pred}_{2} ( x , y ) ,$$

where Pred₁(x,y) and Pred₂(x,y) are the prediction signals for the selected intra prediction modes, Mode1 and Mode2, respectively.

In certain configurations, the encoder 472/decoder 476 may also calculate TM costs for candidate fused prediction signals associated with potential TIMD fusion modes. Specifically, the encoder 472/decoder 476 calculates TM costs not only for candidate intra prediction modes but also for blended prediction signals corresponding to one or more TIMD fusion modes under consideration. For example, the encoder 472/decoder 476 can compute TM cost for the fused prediction signal obtained by blending Mode1 and Mode2 predictions.

More specifically, TM costs for blended prediction signals corresponding to TIMD fusion modes can be calculated as:

$$costFusion = {SATD}_{fused} = {\sum }_{p} \vert T ( {w}_{1} \cdot {Pred}_{1} ( p ) + {w}_{2} \cdot {Pred}_{2} ( p ) - R e c ( p ) ) \vert .$$

w₁ and w₂ are weights associated with two candidate intra prediction modes Mode1 and Mode2. Pred₁(p) and Pred₂(p) are the prediction sample values at position p within the template regions 432-1 and 432-2 for Mode1 and Mode2 respectively. Rec(p) represents the reconstructed sample value at position p in the template regions 432-1 and 432-2. T(⋅) applies transform on the prediction error to compensate for quantization effects. The position p loops through all the pixel samples available in the templates 432-1 and 432-2 during the SATD calculation. These templates provide reconstructed pixel values that serve as references for predicting the CU 450 content.

By calculating the SATD between the fused prediction signal w₁·Pred₁+w₂·Pred₂ and reconstructed samples Rec(p) in templates, we can evaluate TM cost SATD fused for any candidate fusion mode. Lower TM cost indicates the fused prediction can effectively predict template sample values based on reference region 436-1 and 436-2.

Different sets of weights (w₁, w₂) lead to different fused predictions and corresponding SATD_{fused} costs. The encoder 472/decoder 476 calculates TM costs for multiple TIMD fusion modes with various weight combinations. Comparison of costs guides selection of best weighted prediction for final TIMD outcome.

The above formula can incorporate additional intra prediction modes beyond Mode1 and Mode2 if multi-mode fusion is adopted.

The final TIMD prediction, either directly using Mode1 prediction or fusing Mode1 and Mode2 predictions, is determined based on comparison of the TM costs associated with individual candidate intra prediction modes and TM costs related to candidate fused prediction signals. If the TM cost of a fused prediction signal is low enough, the corresponding fusion mode may be selected to generate final TIMD prediction. Otherwise, an intra prediction mode like Mode1 may be chosen instead.

By considering TM costs of fused signals as well when deriving suitable TIMD prediction, the encoder 472/decoder 476 can potentially identify better fusion configurations leading to improved prediction accuracy and compression efficiency. The comparison of TM costs guides whether fusion should be applied or not and also which particular fusion mode works best.

As described supra, the decoder 476 may determine the final TIMD prediction mode (either a single selected mode or a fusion of two modes) based on comparing the TM costs of individual intra modes and TM costs of candidate fused prediction signals, without receiving explicit signaling of this decision in the bitstream. That is, the encoder 472 does not explicitly signal the selected mode.

Specifically, the decoder 476 calculates TM costs for the candidate intra modes derived by TIMD as well as TM costs for one or more candidate fused prediction signals created by blending predictions from different modes. By comparing these TM costs, the video coder can decide whether to use a single mode or enable fusion based on which option yields lower TM cost. This decision on the TIMD prediction mode is made implicitly based on the TM costs without receiving syntax information from the encoder 472. This reduces bitrate overhead while still selecting the optimal TIMD prediction for the CU.

In certain configurations, the encoder 472 first predicts the selected TIMD mode based on comparing TM costs of individual intra modes and fused prediction signals. For example, fusion may be predicted to be used if its TM cost is lower than a scaled version of the best single mode's TM cost. Then one or more syntax elements can be encoded to indicate whether this prediction of the TIMD mode was correct or not.

More specifically, the encoder 472 may send syntax elements, such as flags or indices, to convey the prediction accuracy. For example, the encoder 472 may send a single syntax flag to indicate if fusion is enabled or not, based on the encoder's fusion/non-fusion prediction using TM costs. The encoder 472 may send an index pointing to the best single intra mode or fusion configuration that was predicted to be chosen. The encoder 472 may send a syntax flag confirming if the mode index prediction was accurate.

By first exploiting the TM cost information to predict the TIMD outcome, the encoder reduces the bitrate overhead compared to directly signaling the full decision. But some extra syntax is sent to confirm the prediction decision.

In certain configurations, the encoder 472/decoder 476 selectively chooses between a fusion mode and a single intra prediction mode (Mode1) for the current CU 450. The decision to select the fusion mode is based on the comparison of costMode1 and a predefined threshold determined by scaling the costFusion with a factor α:

$$Selected TIMD Prediction Mode = \{ \begin{matrix}Fusion Mode , & if costMode 1 > α \cdot costFusion , \\ Intra Prediction Model , & otherwise .\end{matrix}$$

Specifically, if costMode1 is greater than a multiplied by costFusion, then the fusion mode is selected as the TIMD prediction mode. Otherwise, the best single intra mode Mode1 is selected. Here, a is a predefined scaling factor used to adjust the threshold for choosing between fusion or not. By comparing the TM costs in this manner without explicitly signaling the decision, the selected TIMD mode can be determined implicitly at both the encoder and decoder side based on the TM cost information.

The scaling factor α is not arbitrarily set but can be adaptively ascertained based on the characteristics of the coding unit 450 itself, including, for example, its size or the specific intra mode (Mode11) initially selected. A larger CU may warrant a higher alpha value in the cost comparison. Setting alpha adaptively can help optimize the decision between single intra mode or fusion mode prediction for the TIMD process.

Furthermore, the value of a can be explicitly signaled by the encoder 472 within the bitstream. This signaling allows for precise and reproducible determination of the fusion threshold at the decoder 476, maintaining consistency in video quality after decoding. In particular, one or more syntax elements can be signaled in high-level parameter sets such as the sequence parameter set (SPS), picture parameter set (PPS), or the picture header (PH).

In certain configurations, after making this initial prediction, the encoder 472 proceeds to actually code the CU 450 with both the predicted mode (either fusion or Mode1) as well as the alternative option between fusion and Mode1. For each tested mode, the encoder 472 calculates the rate-distortion cost. The encoder 472 then selects the mode with the lower final cost after coding to be used as the best mode to code the CU 450.

Additionally, the encoder 472 signals a single syntax flag to indicate whether its initial prediction matched the eventually selected best mode after the full evaluation. By signaling this prediction accuracy flag, the decoder can be aware if the mode chosen based on TM costs differed from the final mode used by the encoder 472.

In certain configurations, the encoder 472/decoder 476 selects the final TIMD prediction mode from a refined candidate list that may include both fusion and non-fusion intra prediction modes. The encoder 472/decoder 476 evaluates the prediction modes by calculating TM costs for each mode. The selection process for the final TIMD prediction mode is not restricted to a single fusion or non-fusion mode; rather, the encoder 472/decoder 476 considers multiple modes from each category.

In one example, the encoder 472/decoder 476 determines a refined candidate list of four intra prediction modes that may include both fusion and non-fusion modes. These modes have the lowest TM costs and the final selected mode may be signaled using a fixed-length code in 2 bits. That is, the final selected mode can be either a fusion or non-fusion mode, chosen from multiple options of each, based on having the best TM cost match to template samples. In this scenario, the varied nature of the refined candidate list enables the encoder 472/decoder 476 to exploit the different characteristics of the video data to improve compression efficiency.

Furthermore, the encoder 472/decoder 476 integrates the predictions derived from templates 432-1 and 432-2 based on the sample values from adjacent reference regions 436-1 and 436-2. These predictions serve as the foundation for calculating the TM costs associated with the MPM list's intra prediction modes.

More than one intra prediction mode may be selected from the MPM list according to a predetermined criterion. The encoder 472/decoder 476, through the calculation of TM costs, holds the capability to compare the efficacy of multiple candidate intra prediction modes and multiple candidate TIMD fusion modes. The chosen TIMD prediction mode for CU 450 is derived based on this multidimensional comparison.

In certain configurations, the encoder/decoder further calculates the TM costs for the fused prediction signals corresponding to different candidate sets of fusion weights for deriving the selected TIMD fusion weights. Different candidate weight sets comprising weight1 and weight2 values are considered to generate fused prediction signals Pred_{fused}(x,y) for the current CUs 450. The template matching (TM) costs are calculated between these fused predictions and reconstructed samples in the template regions 432-1 and 432-2. By comparing the TM costs of the fused signals from different weight sets, the coder selects the set producing lowest TM cost, indicating most efficient TIMD fusion for the CU 450 based on matching template 432 predictions to reference 436 samples.

The encoder 472/decoder 476 may compare the TM costs of fused signals corresponding to different candidate sets to derive the selected TIMD fusion weights for a current CU. The coder evaluates fused prediction signals formed using different fusion weight sets (weight1, weight2). Each set corresponds to a TM cost when fused prediction is compared against 432 template samples. By inspecting these TM costs across candidate sets, the encoder/decoder determines optimal TIMD fusion weights for blending intra predictions to encode CU 450. The set yielding lowest TM cost is chosen.

In some embodiments, the encoder 472/decoder 476 may utilize information on the TM costs of fused signals for determine the selected set of TIMD fusion weights without explicitly signaling syntax information on the selected fusion weights. The decoder 476 can select the fusion weight set for TIMD prediction of CU 450 solely based on TM costs of fused signals, without receiving index or identifier syntax of selected weights. This implicit determination reduces bitstream overhead.

In some other embodiments, the encoder 472/decoder 476 may exploit information on the TM costs of fused signals for predicting the selected set of TIMD fusion weights and signal the selected TIMD weight set index according to the prediction results. The encoder 472/decoder 476 first predicts optimal fusion weights by inspecting TM costs of fused signals. Then weight set index syntax is encoded/decoded to convey chosen set. For example, the encoder 472/decoder 476 may re-order the fusion weight set indices according to the corresponding TM costs from the lowest to the highest. The encoder 472/decoder 476 then further encode or decode one or more syntax elements to signal the selected fusion weight set in the sorted index order. The video coder may only keep some leading candidate weight sets and discard the remaining candidate weight sets after sorting to save the bit cost for signaling the selected weight set index. This leverages TM costs to reduce index range signaled.

Example sets of candidate weight1 values are 0, ¼, ½, ¾, 1, 0, ½, 1 and 0, ⅛, ¼, ⅜, ½, ⅝, ¾, ⅞, 1. Weight2 equals (1−weight1). These define fused prediction signals for TM cost comparison. A candidate set with lowest cost is selected for TIMD of CU 450.

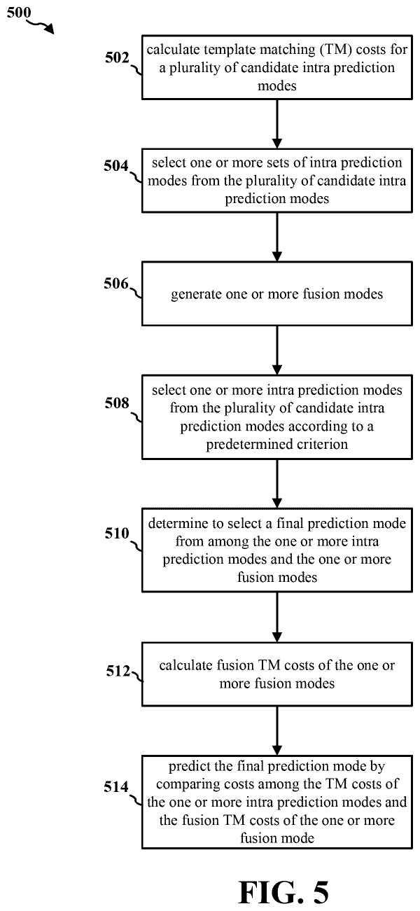

FIG. 5 is a flow chart of a method (process) for coding. The method may be performed by a coder (e.g., the encoder 472/decoder 476). In operation 502, the coder calculates template matching (TM) costs for a plurality of candidate intra prediction modes for a current coding unit (CU) of a video frame being coded. This involves assessing the efficiency of different intra prediction modes by comparing predicted sample values with actual reconstructed sample values adjacent to the CU, using the Sum of Absolute Transformed Differences (SATD) as a cost metric.

Proceeding to operation 504, the coder selects one or more sets of intra prediction modes from the plurality of candidate intra prediction modes. Each set includes at least two intra prediction modes from the plurality, which are considered for generating fusion modes. The selection of these sets is based on predetermined criteria, such as the lowest TM costs.

In operation 506, the coder generates one or more fusion modes. Each fusion mode blends a respective set of intra prediction modes from the one or more sets selected in operation 504. The blending process involves combining the predictions of the selected intra prediction modes using specific fusion weights to create a fused prediction signal.

In operation 508, the coder selects one or more intra prediction modes from the plurality of candidate intra prediction modes according to a predetermined criterion. This criterion typically involves choosing the mode with the lowest TM cost, which is considered the most efficient for coding the CU.

Next, in operation 510, the coder determines to select a final prediction mode from among the one or more intra prediction modes and the one or more fusion modes. In operation 512, the coder calculates fusion TM costs of the one or more fusion modes. This calculation is similar to the TM cost calculation for the intra prediction modes but is applied to the fused prediction signals generated by blending the intra prediction modes.

In operation 514, the coder predicts the final prediction mode by comparing costs among the TM costs of the one or more intra prediction modes and the fusion TM costs of the one or more fusion modes. The final prediction mode may be selected based on which option yields the lowest TM cost, indicating the most efficient prediction for the CU.

In certain configurations, the coder selects a first prediction mode having the lowest TM cost and a second prediction mode having the second-lowest TM cost from the plurality of candidate intra prediction modes. These two modes are then used to create a first fusion mode by blending them with a first set of fusion weights.

In certain configurations, the final prediction mode is the first fusion mode when the fusion TM cost is less than a predefined threshold. This threshold is determined by applying a scaling factor to the TM cost of the first prediction mode. The scaling factor is used to adjust the threshold for selecting between the fusion mode and the intra prediction mode.

In certain configurations, the scaling factor is adjusted based on characteristics of the current CU. This includes considering factors such as the size of the CU and the selected first prediction mode, which can influence the efficiency of the prediction.

In certain configurations, the coder is an encoder and signals the value of the scaling factor within a bitstream. This allows for consistent determination of the predefined threshold between the encoder and a decoder.

In certain configurations, the coder obtains a plurality of sets of candidate fusion weights. The coder selects the first set of fusion weights from the plurality of sets based on comparing TM costs of fusion modes corresponding to the plurality of sets of candidate fusion weights. The set that results in the lowest TM cost may be chosen for the final prediction mode.

In certain configurations, the coder selects the first set of fusion weights implicitly based on the TM costs of the fusion modes. This is done without receiving explicit signaling of the first fusion weights within a bitstream, reducing the amount of data that needs to be transmitted.

In certain configurations, the coder signals an index corresponding to the first set of fusion weights within a bitstream. This index allows the decoder to identify which set of weights was selected for the final prediction mode.

In certain configurations, the plurality of sets of candidate fusion weights include a range of weight values. The first set of fusion weights is selected based on calculating a TM cost for each set to identify the set corresponding to the lowest TM cost.

In certain configurations, one example sets of candidate weight values for the first weights are {0, ¼, ½, ¾, 1}, with the second weights being 1 minus the corresponding first weight. Other example sets may include {0, ½, 1} and {0, ⅛, ¼, ⅜, ½, ⅝, ¾, ⅞, 1}, with the second weights again being 1 minus the corresponding first weight.

In certain configurations, the coder determines the accuracy of the predicted final prediction mode and signals a confirmation flag within a bitstream indicating the determined accuracy. This flag provides feedback on whether the predicted mode based on TM costs matched the actual mode used after the full evaluation.

Below is a description of various features of the present disclosure:

### INTRODUCTION

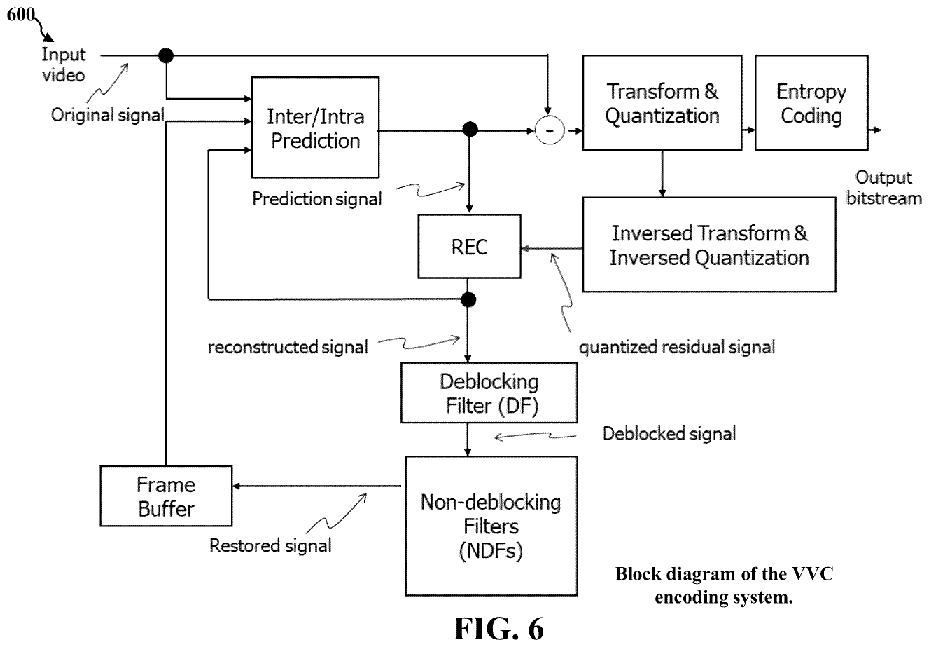

Versatile video coding (VVC) is the latest international video coding standard developed by the Joint Video Expert Team (JVET) of ITU-T SG16 WP3 and ISO/IEC JTC1/SC29 [1]. FIG. 6 provides the block diagram of the VVC encoding system. The input video signal is predicted from the reconstructed signal, which is derived from the coded picture regions. The prediction residual signal is processed by a block transform. The transform coefficients are quantized and entropy coded together with other side information in the bitstream. The reconstructed signal is generated from the prediction signal and the reconstructed residual signal after inverse transform on the de-quantized transform coefficients. The reconstructed signal is further processed by in-loop filtering for removing coding artifacts. The decoded pictures are stored in the frame buffer for predicting the future pictures in the input video signal.

A coded video sequence can be represented by a collection of coded layered video sequences. A coded layered video sequence can be further divided into more than one temporal sublayers. Each coded video data unit belongs to one particular layer identified by the layer index (ID) and one particular sublayer ID identified by the temporal ID. Both layer ID and sublayer ID are signaled in a network abstraction layer (NAL) header. A coded video sequence can be recovered at reduced quality or frame rate by skipping video data units belonging to one or more highest layers or sublayers. The video parameter set (VPS), the sequence parameter set (SPS) and the picture parameter set (PPS) contain high-level syntax elements that apply to a coded video sequence, a coded layered video sequence and a coded picture, respectively. The picture header (PH) and slice header (SH) contain high-level syntax elements that apply to a current coded picture and a current coded slice, respectively.

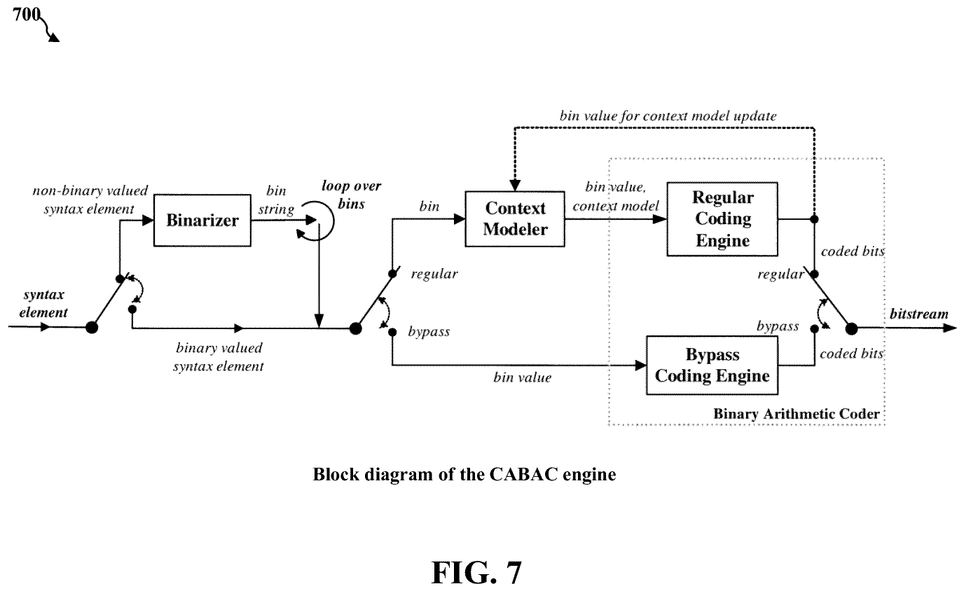

For achieving high compression efficiency, the context-based adaptive binary arithmetic coding (CABAC) mode, or known as regular mode, is employed for entropy coding the values of the syntax elements in VVC. FIG. 7 provides the block diagram of the CABAC process. As the arithmetic coder in the CABAC engine can only encode the binary symbol values, the CABAC operation first needs to convert the value of a syntax element into a binary string, the process commonly referred to as binarization. During the coding process, the accurate probability models are gradually built up from the coded symbols for the different contexts. A set of storage units is allocated to trace the on-going context state, including accumulated probability state, for individual modeling contexts. The context states are initialized using the pre-defined modeling parameters for each context according to the specified slice QP. The selection of a particular modeling context for coding a binary symbol can be determined by a pre-defined rule or derived from the coded information. Symbols can be coded without the context modeling stage and assume an equal probability distribution, commonly referred to as the bypass mode, for improving bitstream parsing throughput rate.

Joint Video Expert Team (JVET) of ITU-T SG16 WP3 and ISO/IEC JTC1/SC29 are currently in the process of exploring the next-generation video coding standard. Some promising new coding tools have been adopted into Enhanced Compression Model 7 (ECM 7) [2] to further improve VVC. The adopted new tools have been implemented in the reference software ECM-7.0 [3].

### DETAILED DESCRIPTION

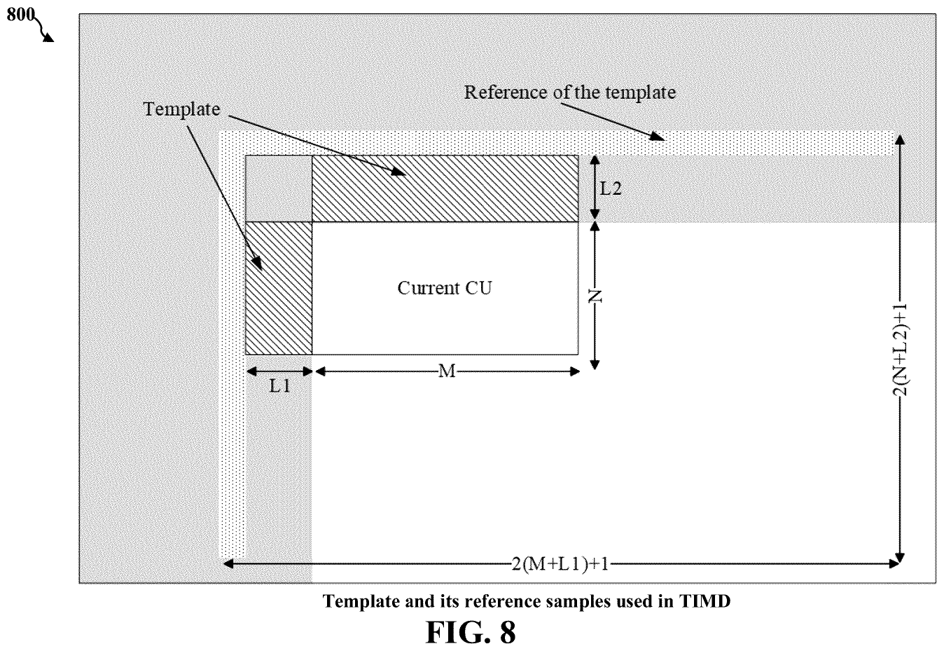

In ECM 7 [2], a template-based intra mode derivation (TIMD) coding tool is developed for intra coding. For each intra prediction mode in most probable mode (MPM) list, the sum of absolute transformed differences (SATD) between the prediction and reconstruction samples of the template shown in FIG. 8 is calculated. First two intra prediction modes with the lowest SATDs are selected as the TIMD intra prediction modes, referred to as Mode1 and Mode2 with Mode1 having the lowest SATD. These two TIMD intra prediction modes are fused with the weights after applying position dependent intra prediction combination (PDPC) process, and such weighted intra prediction is used to code a current CU. A CU syntax flag is coded to indicate whether the TIMD tool is used for coding the current CU or not.

The costs of the two selected modes, costMode1 and costMode2, are compared with a threshold as follows:

$$costMode 2 < 2 * costMode 1.$$

If this condition is true, the fusion is applied, otherwise only the first mode is used.

The assigned weights for the selected intra prediction modes are computed from the corresponding TM costs as follows:

$$weight 1 = costMode 2 / ( costMode 1 + costMode 2 ) \qquad ( 1 )$$

$$weight 2 = 1 - weight 1$$

The fused prediction signal for a pixel sample at position (x,y) is derived by

$$Pred\_fused ( x , y ) = weight 1 * Pred 1 ( x , y ) + weight 2 * Pred 2 ( x , y ) \qquad ( 2 )$$

where Pred1(x,y) and Pred2(x,y) represent the prediction signals corresponding to the selected intra prediction Mode1 and Mode2, respectively.

In the current TIMD method, the selected TIMD prediction mode (fused or not) and fusion weights are determined by the template matching (TM) costs based on SATD calculated for the candidate intra prediction modes from the MPM list. According to one aspect of the present invention, a video coder may further consider the TM costs calculated for fused prediction signals associated with candidate TIMD fusion modes for deriving the final TIMD prediction signal. In the proposed method, a video coder may comprise a plurality of TIMD prediction modes for intra coding a current CU, wherein each TIMD prediction mode corresponds to one intra prediction method and at least one TIMD prediction mode is a fusion mode that corresponds to blending at least two intra predictors to generate the fused prediction signal. The proposed method further comprises calculating the TM costs for the intra prediction modes from the derived candidate intra prediction modes and calculating the TM costs for the blended prediction signals associated with one or more candidate TIMD fusion modes. The final TIMD prediction signal is derived dependent on comparison among the TM costs of the candidate intra prediction modes and the TM costs of one or more candidate TIMD fusion modes.

In one method, the TM costs are further calculated for the fused prediction signals associated with candidate TIMD fusion modes for deriving the selected TIMD prediction mode. A video coder may compare the TM costs of the candidate intra prediction modes and the TM costs of one or more candidate TIMD fusion modes to derive the selected TIMD prediction mode for a current CU. In some embodiments, a video coder may utilize information on the TM costs for determining the selected TIMD mode without explicitly signaling syntax information on selected TIMD mode. In some other embodiments, a video coder may exploit information on the TM costs for predicting the selected TIMD mode and signal the selected TIMD mode index according to the prediction results. In one embodiment based on ECM-7.0, the TM cost is further calculated for the fused prediction signal given by EQ (2). A video coder may determine whether to use the fused mode or not dependent on costMode1 and the TM cost of the fused prediction signal, costFusion. In one implementation, a video coder may determine the selected TIMD prediction mode to be the fusion mode when costMode1>alpha*costFusion and to be intra prediction mode Mode1, otherwise, wherein alpha is a pre-defined scaling factor. In another implementation, a video coder may predict the selected TIMD prediction mode to be the fusion mode when costMode1>alpha*costFusion and to be intra prediction mode Mode1, otherwise. The video coder may further signal a syntax flag to indicate whether the prediction is correct or not. In some embodiments, the scaling factor alpha can be adaptively adjusted. For example, alpha can be adaptively determined according to the selected intra mode Modle1 and/or the size of the current CU. In some embodiments, the value of alpha can be explicitly signaled in the bitstream. The proposed method may further comprise signaling one or more syntax elements in high-level syntax sets such as SPS, PPS, and PH to indicate whether the proposed method is enabled or not.

In another method, the TM costs are further calculated for the fused prediction signals corresponding to different candidate sets of fusion weights for deriving the selected TIMD fusion weights. A video coder may compare the TM costs of fused signals corresponding to different candidate sets to derive the selected TIMD fusion weights for a current CU. In some embodiments, a video coder may utilize information on the TM costs of fused signals for determine the selected set of TIMD fusion weights without explicitly signaling syntax information on the selected fusion weights. In some other embodiments, a video coder may exploit information on the TM costs of fused signals for predicting the selected set of TIMD fusion weights and signal the selected TIMD weight set index according to the prediction results. In one embodiment based on ECM-7.0, the TM costs are further calculated for the fused prediction signal given by EQ (2) for candidate sets of fusion weights (weight1, weight2). In one implementation, a video coder may determine the selected TIMD weight set to be the set corresponding to the lowest TM cost. In another implementation, a video coder may sort the fusion weight set index according to the corresponding TM costs from the lowest cost to the highest cost. The video coder then further encode or decode one or more syntax elements to signal the selected fusion weight set in the sorted index order. The video coder may only keep some leading candidate weight sets and discard the remaining candidate weight sets after sorting to save the bit cost for signaling the selected weight set index. In one example, the set of candidate weight values for weight1 is {0, ¼, ½, ¾, 1} and weight2 is set equal to (1−weight1). Other example sets of candidate weight values for weight1 are {0, ½, 1} and {0, ⅛, ¼, ⅜, ½, ⅝, ¾ ⅞, 1} and weight2 is set equal to (1−weight1). The video coder may further add the fusion weight set currently defined by EQ (1) in ECM-7.0 to the candidate weight set. The proposed method may further comprise signaling one or more syntax elements in high-level syntax sets such as SPS, PPS, and PH to indicate whether the proposed method is enabled or not.

Any of the foregoing proposed methods can be implemented in encoders and/or decoders. For example, any of the proposed methods can be implemented in the intra coding module of an encoder, and/or the intra coding module of a decoder. Alternatively, any of the proposed methods can be implemented as a circuit integrated to the intra coding module of an encoder, and/or the intra coding module of a decoder. The proposed aspects, methods and related embodiments can be implemented individually and jointly in a video coding system.

### REFERENCE

Rec. ITU-T H.266|ISO/IEC 23090-3: Versatile video coding, August 2020.
M. Coban, F. Le Léannec, R.-L. Liao, K. Naser, J. Ström, L. Zhang “Algorithm description of Enhanced Compression Model 7 (ECM 7),” Joint Video Expert Team (JVET) of ITU-T SG 16 WP 3 and ISO/IEC JTC 1/SC 29, Doc. JVET-AB2025, 28th Meeting, Mainz, 20-28 Oct. 2022.
ECM reference software ECM-7.0, available at https://vcgit.hhi.fraunhofer.de/ecm/ECM [Online].

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of video coding, comprising:
calculating, for a current coding unit (CU) of a video frame being coded, template matching (TM) costs for a plurality of candidate intra prediction modes;
selecting one or more sets of intra prediction modes from the plurality of candidate intra prediction modes, each set including at least two intra prediction modes from the plurality of candidate intra prediction modes;
generating one or more fusion modes, each fusion mode blending a respective one set of intra prediction modes of the one or more sets of intra prediction modes;
selecting, from the plurality of candidate intra prediction modes, one or more intra prediction modes according to a predetermined criterion;
determining to select a final prediction mode from among the one or more intra prediction modes and the one or more fusion modes;
calculating fusion TM costs of the one or more fusion modes; and
predicting the final prediction mode by comparing costs among the TM costs of the one or more intra prediction modes and the fusion TM costs of the one or more fusion modes.

2. The method of claim 1, wherein the one or more intra prediction modes is a first prediction mode having the lowest TM cost among the plurality of candidate intra prediction modes, wherein the one or more sets of intra prediction modes is a first set of intra prediction modes including the first prediction mode and a second prediction mode, wherein the second prediction mode has the second-lowest TM cost among the plurality of candidate intra prediction modes;
wherein the one or more fusion modes is a first fusion mode that blends the first prediction mode and the second prediction mode using a first set of fusion weights.

3. The method of claim 2, wherein the final prediction mode is the first fusion mode when the fusion TM cost is less than a predefined threshold determined by applying a scaling factor to the TM cost of the first prediction mode.

4. The method of claim 3, wherein the scaling factor is adjusted based on characteristics of the current CU including at least one of a size of the current CU and the selected first prediction mode.

5. The method of claim 3, further comprising signaling the value of the scaling factor within a bitstream to allow consistent determination of the predefined threshold between an encoder and a decoder.

6. The method of claim 2, further comprising:
obtaining a plurality of sets of candidate fusion weights; and
selecting the first set of fusion weights from the plurality of sets based on comparing TM costs of fusion modes corresponding to the plurality of sets of candidate fusion weights.

7. The method of claim 6, wherein the first set of fusion weights is selected implicitly based on the TM costs of the fusion modes without receiving explicit signaling of the first fusion weights within a bitstream.

8. The method of claim 6, further comprising:
signaling an index corresponding to the first set of fusion weights within a bitstream.

9. The method of claim 6, wherein the plurality of sets of candidate fusion weights include a range of weight values and the first set of fusion weights is selected based on calculating a TM cost for each set to identify the first set corresponding to the lowest TM cost.

10. The method of claim 9, wherein first weights of the plurality of sets of candidate fusion weights are {0, ¼, ½, ¾, 1} and second weights are 1 minus a corresponding first weight.

11. The method of claim 9, wherein first weights of the plurality of sets of candidate fusion weights are {0, ½, 1} and second weights are 1 minus a corresponding first weight.

12. The method of claim 9, wherein first weights of the plurality of sets of candidate fusion weights are {0, ⅛, ¼, ⅜, ½, ⅝, ¾, ⅞, 1} and second weights are 1 minus a corresponding first weight.

13. The method of claim 1, further comprising:
determining an accuracy of the predicted final prediction mode; and
signaling a confirmation flag within a bitstream indicating the determined accuracy.

14. An apparatus for video coding, comprising:
a memory; and
at least one processor coupled to the memory and configured to:
calculate, for a current coding unit (CU) of a video frame being coded, template matching (TM) costs for a plurality of candidate intra prediction modes;
select one or more sets of intra prediction modes from the plurality of candidate intra prediction modes, each set including at least two intra prediction modes from the plurality of candidate intra prediction modes;
generate one or more fusion modes, each fusion mode blending a respective one set of intra prediction modes of the one or more sets of intra prediction modes;
select, from the plurality of candidate intra prediction modes, one or more intra prediction modes according to a predetermined criterion;
determine to select a final prediction mode from among the one or more intra prediction modes and the one or more fusion modes;
calculate fusion TM costs of the one or more fusion modes; and
predict the final prediction mode by comparing costs among the TM costs of the one or more intra prediction modes and the fusion TM costs of the one or more fusion modes.

15. The apparatus of claim 14, wherein the one or more intra prediction modes is a first prediction mode having the lowest TM cost among the plurality of candidate intra prediction modes, wherein the one or more sets of intra prediction modes is a first set of intra prediction modes including the first prediction mode and a second prediction mode, wherein the second prediction mode has the second-lowest TM cost among the plurality of candidate intra prediction modes;
wherein the one or more fusion modes is a first fusion mode that blends the first prediction mode and the second prediction mode using a first set of fusion weights.

16. The apparatus of claim 15, wherein the final prediction mode is the first fusion mode when the fusion TM cost is less than a predefined threshold determined by applying a scaling factor to the TM cost of the first prediction mode.

17. The apparatus of claim 16, wherein the scaling factor is adjusted based on characteristics of the current CU including at least one of a size of the current CU and the selected first prediction mode.

18. The apparatus of claim 16, wherein the at least one processor is further configured to signal the value of the scaling factor within a bitstream to allow consistent determination of the predefined threshold between an encoder and a decoder.

19. The apparatus of claim 15, wherein the at least one processor is further configured to:
obtain a plurality of sets of candidate fusion weights; and
select the first set of fusion weights from the plurality of sets based on comparing TM costs of fusion modes corresponding to the plurality of sets of candidate fusion weights.

20. A computer-readable medium storing computer executable code for video coding, comprising code to:
calculate, for a current coding unit (CU) of a video frame being coded, template matching (TM) costs for a plurality of candidate intra prediction modes;
select one or more sets of intra prediction modes from the plurality of candidate intra prediction modes, each set including at least two intra prediction modes from the plurality of candidate intra prediction modes;
generate one or more fusion modes, each fusion mode blending a respective one set of intra prediction modes of the one or more sets of intra prediction modes;
select, from the plurality of candidate intra prediction modes, one or more intra prediction modes according to a predetermined criterion;
determine to select a final prediction mode from among the one or more intra prediction modes and the one or more fusion modes;
calculate fusion TM costs of the one or more fusion modes; and
predict the final prediction mode by comparing costs among the TM costs of the one or more intra prediction modes and the fusion TM costs of the one or more fusion modes.
